(19) United States
(12) Patent Application Publication
(10) Pub. No.: US 2011/0024159 A1
(43) Pub. Date: Feb. 3, 2011

(54) RELIABLE AND DURABLE CONDUCTIVE FILMS COMPRISING METAL NANOSTRUCTURES

(75) Inventors: Pierre-Marc Allemand, San Jose, CA (US); Manfred Heidecker, Mountain View, CA (US); Teresa Ramos, San Jose, CA (US); Frank Wallace, San Francisco, CA (US)

Correspondence Address: SEED INTELLECTUAL PROPERTY LAW GROUP PLLC, 701 FIFTH AVE, SUITE 5400, SEATTLE, WA, 98104, US

(73) Assignee: CAMBRIOS TECHNOLOGIES CORPORATION, Sunnyvale, CA (US)

(21) Appl. No.: 12/908,730

(22) Filed: Oct. 20, 2010

Related U.S. Application Data
(63) Continuation-in-part of application No. 12/773,734, filed on May 4, 2010.
(60) Provisional application No. 61/175,745, filed on May 5, 2009.

(51) Int. Cl. H01B 5/00; C09D 11/00; B82Y 99/00

(52) U.S. Cl. 174/126.1; 106/31.92; 106/14.05; 977/810

(57) ABSTRACT

Reliable conductive films formed of conductive nanostructures are described. The conductive films have low levels of silver complex ions and show substantially constant sheet resistance following prolonged and intense light exposure.

### CROSS-REFERENCE TO RELATED APPLICATION

This application is a continuation-in-part application of U.S. application Ser. No. 12/773,734, filed May 4, 2010, which application claims the benefit under 35 U.S.C. §119(e) of U.S. Provisional Patent Application No. 61/175,745 filed May 5, 2009, which applications are incorporated herein by reference in their entireties.

### BACKGROUND

1. Technical Field

This disclosure is related to reliable and durable conductive films, in particular, to conductive films exhibiting reliable electrical properties under intense and prolonged light exposure and capable of withstanding physical stresses, and methods of forming the same.

2. Description of the Related Art

Conductive nanostructures, owing to their submicron dimensions, are capable of forming thin conductive films. Often the thin conductive films are optically transparent, also referred to as “transparent conductors.” Thin films formed of conductive nanostructures, such as indium tin oxide (ITO), can be used as transparent electrodes in flat panel electrochromic displays such as liquid crystal displays, plasma displays, touch panels, electroluminescent devices and thin film photovoltaic cells, as anti-static layers and as electromagnetic wave shielding layers.

Co-pending and co-owned U.S. patent application Ser. Nos. 11/504,822, 11/871,767, and 11/871,721 describe transparent conductors formed by interconnecting anisotropic conductive nanostructures such as metal nanowires. Like the ITO films, nanostructure-based transparent conductors are particularly useful as transparent electrodes such as those coupled to thin film transistors in electrochromic displays, including flat panel displays and touch screens. In addition, nanostructure-based transparent conductors are also suitable as coatings on color filters and polarizers, and so forth. The above co-pending applications are incorporated herein by reference in their entireties.

There is a need to provide reliable and durable nanostructure-based transparent conductors to satisfy the rising demand for quality display systems.

### BRIEF SUMMARY

Reliable and durable conductive films formed of conductive nanostructures are described.

One embodiment provides a conductive film comprising: a metal nanostructure network layer that includes a plurality of metal nanostructures, the conductive film having a sheet resistance that shifts no more than 20% during exposure to a temperature of at least 85° C. for at least 250 hours.

In various further embodiments, the conductive film is also exposed to 85% humidity during the 85° C. temperature exposure.

In other embodiments, the conductive film has a sheet resistance that shifts no more than 10% during exposure to a temperature of at least 85° C. for at least 250 hours, or shifts no more than 10% during exposure to a temperature of at least 85° C. for at least 500 hours, or shifts no more than 10% during exposure to a temperature of at least 85° C. and a humidity of no more than 2% for at least 1000 hours.

In various embodiments, the conductive film comprises a silver nanostructure network layer having less than 2000 ppm of silver complex ions in total, wherein the silver complex ions include nitrate, fluoride, chloride, bromide, iodide ions, or a combination thereof.

In a further embodiment, the conductive film comprises less than 370 ppm chloride ions.

In other embodiments, the conductive film further comprises one or more viscosity modifiers, and wherein the viscosity modifier is hydroxypropyl methylcellulose (HPMC) that is purified to remove nitrate, fluoride, chloride, bromide, iodide ions, or a combination thereof.

In further embodiments, the conductive film further comprises a first corrosion inhibitor. In another embodiment, the conductive film further comprises an overcoat overlying the metal nanostructure network layer, wherein the overcoat comprises a second corrosion inhibitor.

In certain embodiments, the conductive film is photo-stable and has a sheet resistance that shifts no more than 20% over 400 hours under 30,000 Lumens light intensity.

Another embodiment provides a method comprising: providing a suspension of silver nanostructures in an aqueous medium; adding to the suspension a ligand capable of forming a silver complex with silver ions; allowing the suspension to form sediments containing the silver nanostructures and a supernatant having halide ions; and separating the supernatant with halide ions from the silver nanostructures.

In further embodiments, the ligand is cyano (CN⁻), thiocyanate (SCN⁻), or thiosulfate (S₂O₃⁻).

Yet another embodiment provides a purified ink formulation comprising: a plurality of silver nanostructures; a liquid carrier; a trace amount of silver complex ions, wherein the silver complex ions and plurality of silver nanostructures are present in a (w/w) ratio of no more than 1:500, no more than 1:250, no more than 1:170, no more than 1:125, no more than 1:100, no more than 1:85, no more than 1:75, no more than 1:65, or no more than 1:35.

In further embodiment, the purified ink formulation comprises silver nanostructures that are purified to remove nitrate, fluoride, chloride, bromide, iodide ions, or a combination thereof.

In a further embodiment, the purified ink formulation further comprises a corrosion inhibitor.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been selected solely for ease of recognition in the drawings.

FIG. 1 shows comparative results of shifts in sheet resistance in conductive films formed of purified silver nanowires vs. unpurified silver nanowires.

FIG. 2 shows comparative results of shifts in sheet resistance in conductive films formed of purified hydroxypropyl methylcellulose (HPMC) vs. unpurified HPMC.

FIGS. 3 and 4 show comparative results of shifts in sheet resistance in conductive films with a corrosion inhibitor vs. without a corrosion inhibitor in respective ink formulations.

FIGS. 5 and 6 show comparative results of shifts in sheet resistance in conductive films with a corrosion inhibitor vs. without a corrosion inhibitor in respective overcoat layers.

### DETAILED DESCRIPTION OF THE INVENTION

Interconnecting conductive nanostructures can form a nanostructure network layer, in which one or more electrically conductive paths can be established through continuous physical contacts among the nanostructures. This process is also referred to as percolation. Sufficient nanostructures must be present to reach an electrical percolation threshold such that the entire network becomes conductive. The electrical percolation threshold represents an important value above which long range connectivity can be achieved. Typically, the electrical percolation threshold correlates with the loading density or concentration of the conductive nanostructures in the nanostructure network layer.

### Conductive Nanostructures

As used herein, “conductive nanostructures” or “nanostructures” generally refer to electrically conductive nano-sized structures, at least one dimension of which is less than 500 nm, more preferably, less than 250 nm, 100 nm, 50 nm or 25 nm.

The nanostructures can be of any shape or geometry. In certain embodiments, the nanostructures are isotropically shaped (i.e., aspect ratio=1). Typical isotropic nanostructures include nanoparticles. In preferred embodiments, the nanostructures are anisotropically shaped (i.e., aspect ratio≠1). As used herein, aspect ratio refers to the ratio between the length and the width (or diameter) of the nanostructure. The anisotropic nanostructure typically has a longitudinal axis along its length. Exemplary anisotropic nanostructures include nanowires and nanotubes, as defined herein.

The nanostructures can be solid or hollow. Solid nanostructures include, for example, nanoparticles and nanowires. “Nanowires” thus refers to solid anisotropic nanostructures. Typically, each nanowire has an aspect ratio (length:diameter) of greater than 10, preferably greater than 50, and more preferably greater than 100. Typically, the nanowires are more than 500 nm, more than 1 μm, or more than 10 μm long.

Hollow nanostructures include, for example, nanotubes. Typically, the nanotube has an aspect ratio (length:diameter) of greater than 10, preferably greater than 50, and more preferably greater than 100. Typically, the nanotubes are more than 500 nm, more than 1 μm, or more than 10 μm in length.

The nanostructures can be formed of any electrically conductive material. Most typically, the conductive material is metallic. The metallic material can be an elemental metal (e.g., transition metals) or a metal compound (e.g., metal oxide). The metallic material can also be a bimetallic material or a metal alloy, which comprises two or more types of metal. Suitable metals include, but are not limited to, silver, gold, copper, nickel, gold-plated silver, platinum and palladium. The conductive material can also be non-metallic, such as carbon or graphite (an allotrope of carbon).

### Ink Compositions

To prepare a nanostructure network layer, a liquid dispersion of the nanostructures can be deposited on a substrate, followed by a drying or curing process. The liquid dispersion is also referred to as an “ink composition” or “ink formulation.” The ink composition typically comprises a plurality of nanostructures and a liquid carrier.

Because anisotropic nanostructures of high aspect ratio (e.g., greater than 10) promote the formation of an efficient conductive network, it is desirable that the nanostructures of the ink composition uniformly have aspect ratios of greater than 10 (e.g., nanowires). However, in certain embodiments, a relatively small amount of nanostructures with aspect ratios of 10 or less (including nanoparticles), as a by-product of the nanowire synthesis, may be present. Thus, unless otherwise specified, conductive nanostructures should be understood to be inclusive of nanowires and nanoparticles. Further, as used herein, unless specified otherwise, “nanowires,” which represent the majority of the nanostructures in the ink composition and the conductive film based on the same, may or may not be accompanied by a minor amount of nanoparticles or other nanostructures having aspect ratios of 10 or less.

The liquid carrier can be any suitable organic or inorganic solvent or solvents, including, for example, water, a ketone, an alcohol, or a mixture thereof. The ketone-based solvent can be, for example, acetone, methylethyl ketone, and the like. The alcohol-based solvent can be, for example, methanol, ethanol, isopropanol, ethylene glycol, diethylene glycol, triethylene glycol, propylene glycol, and the like.

The ink composition may further include one or more agents that prevent or reduce aggregation or corrosion of the nanostructures, and/or facilitate the immobilization of the nanostructures on the substrate. These agents are typically non-volatile and include surfactants, viscosity modifiers, corrosion inhibitors and the like.

In certain embodiments, the ink composition includes surfactants, which serve to reduce aggregation of the nanostructures. Representative examples of suitable surfactants include fluorosurfactants such as ZONYL® surfactants, including ZONYL® FSN, ZONYL® FSO, ZONYL® FSA, ZONYL® FSH (DuPont Chemicals, Wilmington, Del.), and NOVEC™ (3M, St. Paul, Minn.). Other exemplary surfactants include non-ionic surfactants based on alkylphenol ethoxylates. Preferred surfactants include, for example, octylphenol ethoxylates such as TRITON™ (x100, x114, x45), and nonylphenol ethoxylates such as TERGITOL™ (Dow Chemical Company, Midland Mich.). Further exemplary non-ionic surfactants include acetylenic-based surfactants such as DYNOL® (604, 607) (Air Products and Chemicals, Inc., Allentown, Pa.) and n-dodecyl β-D-maltoside.

In certain embodiments, the ink composition includes one or more viscosity modifiers, which serve as a binder that immobilizes the nanostructures on a substrate. Examples of suitable viscosity modifiers include hydroxypropyl methylcellulose (HPMC), methyl cellulose, xanthan gum, polyvinyl alcohol, carboxy methyl cellulose, and hydroxy ethyl cellulose.

In particular embodiments, the ratio of the surfactant to the viscosity modifier is preferably in the range of about 80 to about 0.01; the ratio of the viscosity modifier to the metal nanowires is preferably in the range of about 5 to about 0.000625; and the ratio of the metal nanowires to the surfactant is preferably in the range of about 560 to about 5. The ratios of components of the ink composition may be modified depending on the substrate and the method of application used. The preferred viscosity range for the ink composition is between about 1 and 100 cP.

### Conductive Films

A nanostructure network layer is formed following the ink deposition and after the liquid carrier is at least partially dried or evaporated. The nanostructure network layer thus comprises nanostructures that are randomly distributed and interconnect with one another. The nanostructure network layer often takes the form of a thin film that typically has a thickness comparable to that of a diameter of the conductive nanostructure. As the number of the nanostructures reaches the percolation threshold, the thin film is electrically conductive and is referred to as a “conductive film.” Other non-volatile components of the ink composition, including, for example, one or more surfactants and viscosity modifiers, may form parts of the conductive film. Thus, unless specified otherwise, as used herein, “conductive film” refers to a nanostructure network layer formed of networking and percolative nanostructures combined with any of the non-volatile components of the ink composition, and may include, for example, one or more of the following: viscosity modifier, surfactant and corrosion inhibitor. In certain embodiments, a conductive film may refer to a composite film structure that includes said nanostructure network layer and additional layers such as an overcoat or barrier layer.

Typically, the longer the nanostructures, the fewer nanostructures are needed to achieve percolative conductivity. For anisotropic nanostructures, such as nanowires, the electrical percolation threshold or the loading density is inversely related to the length² of the nanowires. Co-pending and co-owned application Ser. No. 11/871,053, which is incorporated herein by reference in its entirety, describes in detail the theoretical as well as empirical relationship between the sizes/shapes of the nanostructures and the surface loading density at the percolation threshold.

The electrical conductivity of the conductive film is often measured by “film resistivity” or “sheet resistance,” which is represented by ohm/square (or “Ω/□”). The film resistance is a function of at least the surface loading density, the size/shapes of the nanostructures, and the intrinsic electrical property of the nanostructure constituents. As used herein, a thin film is considered conductive if it has a sheet resistance of no higher than 10⁸ Ω/□. Preferably, the sheet resistance is no higher than 10⁴ Ω/□, 3,000 Ω/□, 1,000 Ω/□, or 100 Ω/□. Typically, the sheet resistance of a conductive network formed by metal nanostructures is in the ranges of from 10 Ω/□ to 1000 Ω/□, from 100 Ω/□ to 750 Ω/□, from 50 Ω/□ to 200 Ω/□, from 100 Ω/□ to 500 Ω/□, from 100 Ω/□ to 250 Ω/□, from 10 Ω/□ to 200 Ω/□, from 10 Ω/□ to 50 Ω/□, or from 1 Ω/□ to 10 Ω/□.

Optically, the conductive film can be characterized by “light transmission” as well as “haze.” Transmission refers to the percentage of an incident light transmitted through a medium. The incident light refers to ultra-violet (UV) or visible light having a wavelength between about 250 nm to 800 nm. In various embodiments, the light transmission of the conductive film is at least 50%, at least 60%, at least 70%, at least 80%, at least 85%, at least 90%, or at least 95%. The conductive film is considered “transparent” if the light transmission is at least 85%. Haze is an index of light diffusion. It refers to the percentage of the quantity of light separated from the incident light and scattered during transmission (i.e., transmission haze). Unlike light transmission, which is largely a property of the medium (e.g., the conductive film), haze is often a production concern and is typically caused by surface roughness and embedded particles or compositional heterogeneities in the medium. In various embodiments, the haze of the transparent conductor is no more than 10%, no more than 8%, no more than 5%, or no more than 1%.

### Reliability in Sheet Resistance

Long-term reliability as measured by stable electrical and optical properties of a conductive film is an important indicator of its performance.

For instance, ink formulations comprising silver nanostructures can be cast into conductive films that are typically less than 1000 Ω/□ in sheet resistance and in over 90% in light transmission, making them suitable as transparent electrodes in display devices, such as LCDs and touch screens. See, e.g., co-pending and co-owned applications U.S. patent application Ser. Nos. 11/504,822, 11/871,767, 11/871,721, and 12/106,244. When positioned in a light path in any of the above devices, the conductive film is exposed to prolonged and/or intensive light during a normal service life of the device. Thus, the conductive film needs to meet certain criteria to ensure long-term photo-stability.

It has been observed that the sheet resistance of conductive films formed of silver nanostructures may change or drift during light exposure. For example, over 30% increase in sheet resistance has been observed in conductive films formed of silver nanowires over a time period of 250-500 hours in ambient light.

The drift in sheet resistance is also a function of the intensity of light exposure. Typically, light intensity is measured in Lumens, which is a unit of luminous flux. Under an accelerated light condition, which is about 30 to 100 times more intense than ambient light, the drift in sheet resistance occurs much faster and more dramatically. As used herein, “accelerated light condition” refers to an artificial or testing condition that exposes the conductive films to continuous and intense simulated light. Often, the accelerated light condition can be controlled to simulate the amount of light exposure that the conductive film is subjected to during a normal service life of a given device. Under the accelerated light condition, the light intensity is typically significantly elevated compared to the operating light intensity of the given device; the duration of the light exposure for testing the reliability of the conductive films can therefore be significantly shortened compared to the normal service life of the same device.

Through optical microscopy, such as Scanning Electron Microscope (SEM) and Transmission Electron Microscope (TEM), it was observed that the silver nanowires in the conductive films having increased resistivity appeared broken in places, thinned, or otherwise structurally compromised. The fractures of the silver nanowires reduce the number of percolation sites (i.e., where two nanowires contact or cross) and cause multiple failures in the conductive paths, which in turn results in an increase in the sheet resistance, i.e., a decrease in conductivity.

To reduce the incidence of light-induced structural damage to the silver nanostructures following prolonged light exposure, certain embodiments describe a reliable and photo-stable conductive film of silver nanostructures, which has a sheet resistance that shifts no more than 20% over a period of at least 300 hours in accelerated light condition (30,000 Lumens), or no more than 20% over a period of at least 400 hours, or no more than 10% over a period of at least 300 hours, and method of making the same.

In addition to prolonged light exposure, environmental factors, such as higher than ambient temperature and humidity, as well as atmospheric corrosive elements, can also potentially influence film reliability. Thus, additional criteria for assessing the reliability of a conductive film include a substantially constant sheet resistance that shifts no more than 10-30% (e.g., no more than 20%) over a period of at least 250-500 hours (e.g., at least 250 hours) at 85° C. and 85% humidity.

To achieve the above levels of reliability, agents that potentially interfere with the physical integrity of the silver nanostructures under light exposure or environmental elements are removed or minimized. Further, the conductive films are protected from other environmental elements by incorporating one or more barrier layers (overcoats), as well as corrosion inhibitors.

### A. Removal of Silver Complex Ions

It is observed that certain light-sensitive silver complexes, such as silver halides and silver nitrate, are consistently associated with the thinned, nicked, or cut silver nanostructures in a silver nanostructure network layer that has been exposed to light and/or environmental elements.

The sources of the silver complexes vary and may include residual reactants (e.g., silver nitrate) from the synthesis of silver nanowires, and one or more byproducts of the synthesis (e.g., silver halide). As used herein, a “silver complex” or a “silver salt” refers to a chemical substance that comprises a silver ion (Ag⁺) and a counter ion, held together by ionic force or electrostatic attraction. In certain embodiments, a silver salt may be soluble in an aqueous medium, in which case the silver ion and the counter ion dissociate and are present in the aqueous medium as free silver ion (Ag⁺) and free counter ion. For example, silver nitrate dissociates into free silver ions and free nitrate ions. In other embodiments, a silver salt may be insoluble in an aqueous medium, in which case the silver ion and the counter ion remain bound to each other by ionic force. Silver chloride, silver bromide and silver iodide are examples of insoluble silver salts.

The presence of silver complexes among the silver nanowires can cause a marked increase in the sheet resistance of a conductive film formed of silver nanowires after a prolonged light exposure, and/or under certain environmental conditions (e.g., higher than ambient temperature and humidity). As shown in Examples 8 and 9, the sheet resistance of conductive films prepared by standard processes, i.e., without any purification to remove silver chloride, increased sharply (more than 200%) following 400 hours of intense light exposure at 32,000 Lumens. In contrast, in conductive films that have been purified to remove or minimize the amount of chloride ions, the sheet resistance remained stable (no more than 5-20% shift) following 400 hours of intense light exposure (32,000 Lumens).

Insoluble silver complex can form as a by-product during silver nanowire synthesis and will be introduced to the ink composition unless steps are taken to separate the insoluble silver complex from the silver nanowires. More specifically, during nanowire synthesis, silver ions (Ag⁺) are reduced to elemental silver (Ag) in the presence of a reducing agent and an ionic additive (e.g., Example 1). See also co-pending, co-owned U.S. patent application Ser. No. 11/766,552. Typically, the ionic additive is a tetraalkylammonium halide that serves to manage or control the shapes of the growing nanowires. The halide ion (e.g., chloride or bromide) and the silver ion thus form one or more insoluble silver salts. Because the insoluble silver halide tends to co-precipitate with the silver nanowires, it is difficult, if not impossible, to separate the insoluble silver halide from the silver nanowires during a normal work-up following the synthesis, which typically involves washing with an aqueous solution, sedimentation of the nanowires and decantation of the supernatant. Other separation methods, such as filtration, dialysis, or centrifugation, are also ineffective in separating the insoluble silver halides from the silver nanowires.

A method is provided herein of purifying silver nanostructures to minimize or limit the content of the insoluble silver salt in the ink composition and the conductive film formed thereof. As used herein, “purify” refers to separating and removing one or more silver salts, both soluble and insoluble, from the silver nanostructures. It is desirable that all of the silver salts are removed following purification of the silver nanostructures, resulting in no detectable level of any silver salt in the ink composition and conductive film. However, one skilled in the art would recognize that it is also possible that not all of the silver salts (soluble or insoluble) are removed following the purification process, and a trace amount of silver salts (measured by the amount of silver complex ions) may remain in the ink composition and the conductive film.

More specifically, the method comprises converting an insoluble silver salt to a soluble silver coordination complex, and subsequently removing the soluble silver coordination complex. As an ionic compound, insoluble silver halide (AgX), wherein X is Br, Cl or I, silver ions (Ag⁺) and halide ions (X⁻) coexist in an aqueous medium in equilibrium, shown below as Equilibrium (1). As an example, silver chloride has a very low dissociation constant (1.76×10⁻¹⁰ at 25° C.), and Equilibrium (1) overwhelmingly favors the formation of the insoluble, solid silver halide, resulting in negligible amounts of free silver ion and free halide ion. In order to solubilize an insoluble silver halide (such as silver chloride, silver bromide and silver iodide), a ligand, e.g., ammonia (NH₃), may be added in the form of ammonium hydroxide (NH₄OH) to form a stable coordination complex with the silver ion: Ag(NH₃)₂⁺, shown below as Equilibrium (2). Ag(NH₃)₂⁺ has an even lower dissociation constant than that of silver halide, thus shifting Equilibrium (1) to favor the formation of Ag⁺ and free halide ions.

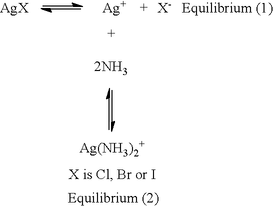

Once free halide ions are released from the insoluble silver halide, the halide ions are predominantly present in the aqueous phase while the silver nanostructures remain suspended as a solid. The halide ions can thus be separated from silver nanostructures via sedimentation and decantation, filtration, centrifugation, or any other means that separates a liquid phase from a solid phase.

Thus, one embodiment provides a method of removing silver halide comprising: providing a suspension of silver nanostructures in an aqueous medium; and adding to the suspension a ligand capable of forming a soluble silver coordination complex with silver ions, allowing for separation of the suspended solid nanostructures from the free halide ions that have been released into the liquid phase.

As used herein, a silver coordination complex comprises a silver ion (Ag⁺) and one or more neutral or charged ligands, held together by coordination bonds. In addition to ammonia, other ligands that have high affinity for silver ions (Ag⁺) include, for example, cyano (CN⁻), thiocyanate (SCN⁻), and thiosulfate (S₂O₃), which form stable silver coordination complexes Ag(CN)₂, Ag(SCN)₂⁻, and Ag(S₂O₃)₂³⁻, respectively. The aqueous medium includes water, which can be optionally combined with one or more additional water-miscible co-solvents. Typically, the co-solvent is an alcohol-based organic solvent, which includes, for example, methanol, ethanol, isopropanol, and polyols such as ethylene glycol, propylene glycol, etc.

Light-sensitive or environmentally-sensitive silver complexes are not limited to insoluble silver salts. Conductive films contaminated with an unacceptable level of soluble salts, such as silver nitrate and silver fluoride, may also cause the sheet resistance to shift after a prolonged light exposure, and/or under certain environmental conditions (e.g., higher than ambient temperature and humidity).

Soluble silver complexes such as silver nitrate and silver fluoride can be removed by repeatedly washing a suspension of the silver nanostructures. In some embodiments, these soluble ions may also be simultaneously removed with the halides during purification of silver nanostructures.

A further source of silver complex ions in the conductive films is introduced through one or more components other than the silver nanostructures in the ink formulation. For example, commercial hydroxypropyl methylcellulose (HPMC), which is frequently used in the ink formulations as a binder, contains residual chloride (up to approximately 15,000 ppm by weight). The chloride in the commercial HPMC can be removed by multiple hot water washes. The amount of chloride can thus be reduced to about 10-40 ppm.

Alternatively, the chloride can be removed by dialysis against deionized water for several days until the level of chloride is below 100 ppm, preferably below 50 ppm, and more preferably below 20 ppm.

Alternatively, the chloride can be removed by forming an aqueous solution of HPMC and passing the resulting solution through an appropriate ion exchange resin bed.

In addition, certain surfactants such as ZONYL® FSA may also contain silver complex ions (e.g., chloride) in their commercial form. Similar to the purification of HPMC, the surfactants can also be purified to remove a part or all of the silver complex ions.

Thus, various embodiments provide ink compositions in which the amount of silver salt is minimized or limited to below a certain level. The level of the silver salts in the ink composition or the conductive film formed thereof is typically measured and represented by the amount of silver complex ion, which is the counter ion of the silver ion in a given silver salt. As used herein, the term “silver complex ions” encompasses counter ions that form an insoluble salt with the silver ion as well as counter ions that form a soluble salt with the silver ion. Thus, the silver complex ions may be “bound ions” (e.g., chloride, bromide and iodide) that are in the form of an insoluble silver salt. The silver complex ions may also be “free ions” or “dissociated ions” (e.g., nitrate and fluoride) that are in the form of a soluble silver salt, which freely dissociate into ionic species in an aqueous medium. In certain embodiments, the silver complex ions in the ink composition include both free ions and bound ions. In other embodiments, the ink composition contains no detectable level of free halide ions (e.g., chloride or bromide ion). Instead, these halide ions, if present, are predominantly bound to silver ions. In certain embodiments, the silver complex ions in an ink composition are all bound ions, i.e., in the form of insoluble silver salts.

Thus, one embodiment provides an ink formulation comprising: a plurality of silver nanostructures, a liquid carrier, and a trace amount of silver complex ions (including NO₃⁻, F⁻, Br⁻, Cl⁻, I⁻, or a combination thereof), wherein the silver complex ions and the plurality of silver nanostructures are present in a (w/w) ratio of no more than 1:65. Additional embodiments provide ink formulations in which the silver complex ions and the plurality of silver nanostructures are present in a ratio of no more than 1:500, no more than 1:250, no more than 1:170, no more than 1:125, no more than 1:100, no more than 1:85, no more than 1:75, or no more than 1:35. As used herein, “trace amount” may encompass zero or no detectable amount of silver complex ions. Similarly, “less than” or “no more than” may encompass, at the lower limit, zero or no detectable amount of silver complex ions. In a preferred embodiment, the silver nanostructures are prepared by a “polyol” synthetic approach that involves reducing a silver complex (e.g., silver nitrate) in a polyol solvent (e.g., ethylene glycol or propylene glycol).

A specific embodiment provides an ink formulation comprising 0.05 w/w % silver nanostructures, 0.1 w/w % HPMC, and no more than 0.5 ppm of silver complex ions. Another specific embodiment provides an ink formulation comprising 0.05 w/w % silver nanostructures, 0.1 w/w % HPMC, and no more than 1 ppm of silver complex ions. A further specific embodiment provides an ink formulation comprising 0.05 w/w % silver nanostructures, 0.1 w/w % HPMC, and no more than 2 ppm of silver complex ions. A further specific embodiment provides an ink formulation comprising 0.05 w/w % silver nanostructures, 0.1 w/w % HPMC, and no more than 3 ppm of silver complex ions. A further specific embodiment provides an ink formulation comprising 0.05 w/w % silver nanostructures, 0.1 w/w % HPMC, and no more than 4 ppm of silver complex ions. A further specific embodiment provides an ink formulation comprising 0.05 w/w % silver nanostructures, 0.1 w/w % HPMC, and no more than 5 ppm of silver complex ions. A further specific embodiment provides an ink formulation comprising 0.05 w/w % silver nanostructures, 0.1 w/w % HPMC, and no more than 6 ppm of silver complex ions. A further specific embodiment provides an ink formulation comprising 0.05 w/w % silver nanostructures, 0.1 w/w % HPMC, and no more than 7 ppm of silver complex ions. A further specific embodiment provides an ink formulation comprising 0.05 w/w % silver nanostructures, 0.1 w/w % HPMC, and no more than 8 ppm of silver complex ions. A further specific embodiment provides an ink formulation comprising 0.05 w/w % silver nanostructures, 0.1 w/w % HPMC, and no more than 15 ppm of silver complex ions.

Further, in any one of the above embodiments, the silver complex ions are chloride ions.

Further, various embodiments provide conductive films of silver nanostructures that has no more than 2000 ppm, 1500 ppm, or 1000 ppm of the silver complex ions in total. As used herein, “in total” means all types of silver complex ions (including any combinations of NO₃⁻, F⁻, Br⁻, Cl⁻, and I⁻) that are present in the conductive film. As discussed herein in more detail, the silver complex ions may be introduced into the conductive film from one or more sources, including silver nanowires, viscosity modifier and/or surfactants. In more specific embodiments, there are no more than 400 ppm, no more than 370 ppm, no more 100 ppm, or no more than 40 ppm of any single type of silver complex ion in the conductive film. In various embodiments, the silver nanostructures network layer comprises purified silver nanostructures, or purified silver nanostructures in combination with purified HPMC, as described herein.

In any of the above embodiments, the silver complex ions may be all bound to silver ions in the form of insoluble silver salts. In other embodiments, the silver complex ions are chloride ions.

In certain embodiments, the silver complex ions in any of the above embodiments are completely absent (i.e., 0 ppm) in the ink composition and the corresponding conductive film.

### B. Environmental Reliability of Conductive Films

In addition to reducing or eliminating the silver complex ions, reliability of the conductive film can be further enhanced by protecting the silver nanostructures against adverse environmental influences, including atmospheric corrosive elements. For example, a trace amount of H₂S in the atmosphere can cause corrosion of silver nanostructures, resulting in a decrease of conductivity in the conductive film. In certain circumstances, the environmental influences on the conductivity of the silver nanostructures may be more pronounced at an elevated temperature and/or humidity, even after the silver nanostructures and/or the HPMC have been purified as described herein.

According to certain embodiments described herein, conductive films formed by metal nanowire networks can withstand the environmental elements at ambient conditions, or at an elevated temperature and/or humidity.

In certain specific embodiments, the conductive film has a sheet resistance that shifts no more than 20% during exposure to a temperature of at least 85° C. for at least 250 hours.

In certain embodiments, the conductive film has a sheet resistance that shifts no more than 10% during exposure to a temperature of at least 85° C. for at least 250 hours.

In certain embodiments, the conductive film has a sheet resistance that shifts no more than 10% during exposure to a temperature of at least 85° C. for at least 500 hours.

In further embodiments, the conductive film has a sheet resistance that shifts no more than 20% during exposure to a temperature of at least 85° C. and a humidity of up to 85% for at least 250 hours.

In further embodiments, the conductive film has a sheet resistance that shifts no more than 10% during exposure to a temperature of at least 85° C. and a humidity of up to 85% for at least 250 hours.

In further embodiments, the conductive film has a sheet resistance that shifts no more than 10% during exposure to a temperature of at least 85° C. and a humidity of up to 85% for at least 500 hours.

In further embodiments, the conductive film has a sheet resistance that shifts no more than 10% during exposure to a temperature of at least 85° C. and a humidity of no more than 2% for at least 1000 hours.

Thus, various embodiments describe adding corrosion inhibitors to neutralize the corrosive effects of the atmospheric H₂S. Corrosion inhibitors serve to protect the silver nanostructures from exposure to H₂S through a number of mechanisms. Certain corrosion inhibitors bind to the surface of the silver nanostructures and form a protective layer that insulates the silver nanostructures from corrosive elements, including, but not limited to, H₂S. Other corrosion inhibitors react with H₂S more readily than H₂S does with silver, thus acting as an H₂S scavenger.

Suitable corrosion inhibitors include those described in applicants' co-pending and co-owned U.S. patent application Ser. No. 11/504,822. Exemplary corrosion inhibitors include, but are not limited to, benzotriazole (BTA), alkyl substituted benzotriazoles, such as tolytriazole and butyl benzyl triazole, 2-aminopyrimidine, 5,6-dimethylbenzimidazole, 2-amino-5-mercapto-1,3,4-thiadiazole, 2-mercaptopyrimidine, 2-mercaptobenzoxazole, 2-mercaptobenzothiazole, 2-mercaptobenzimidazole, lithium 3-[2-(perfluoroalkyl)ethylthio]propionate, dithiothiadiazole, alkyl dithiothiadiazoles and alkylthiols (alkyl being a saturated C₆-C₂₄ straight hydrocarbon chain), triazoles, 2,5-bis(octyldithio)-1,3,4-thiadiazole, dithiothiadiazole, alkyl dithiothiadiazoles, alkylthiols acrolein, glyoxal, triazine, and n-chlorosuccinimide.

The corrosion inhibitors can be added into the conductive films described herein through any means. For example, the corrosion inhibitor can be incorporated into an ink formulation and dispersed within the nanostructure network layer. Certain additives to the ink formulation may have the duel functions of serving as a surfactant and a corrosion inhibitor. For example, ZONYL® FSA may function as a surfactant as well as a corrosion inhibitor. Additionally or alternatively, one or more corrosion inhibitors can be embedded in an overcoat overlying the nanostructure layer of silver nanostructures.

Thus, one embodiment provides a conductive film comprising: a nanostructure network layer including a plurality of silver nanostructures and having less than 1500 ppm silver complex ions; and an overcoat overlying the nanostructure network layer, the overcoat including a corrosion inhibitor.

Another embodiment provides a conductive film comprising: a nanostructure network layer having less than 750 ppm silver complex ions and including a plurality of silver nanostructures and a corrosion inhibitor; and an overcoat overlying the nanostructure network layer.

A further embodiment provides a conductive film comprising: a nanostructure network layer having less than 370 ppm silver complex ions and including a plurality of silver nanostructures and a first corrosion inhibitor; and an overcoat overlying the nanostructure network layer, the overcoat including a second corrosion inhibitor.

In any one of the above embodiments, the silver complex ions are chloride ions.

In certain embodiments, the first corrosion inhibitor is alkyl dithiothiadiazoles, and the second corrosion inhibitor is ZONYL® FSA.

In any of the above embodiments directed to low-halide, low-nitrate conductive films, the conductive film has a sheet resistance that shifts no more than 10%, or no more than 20% during exposure to a temperature of at least 85° C. for at least 250 hours, or at least 500 hours. In certain embodiments, the conductive film is also exposed to less than 2% humidity. In other embodiments, the conductive film is also exposed to up to 85% humidity.

The overcoat, with or without a corrosion inhibitor, also forms a physical barrier to protect the nanowire layer from the impacts of temperature and humidity, and any fluctuation thereof, which can occur during a normal operative condition of a given device. The overcoat can be one or more of a hard coat, an anti-reflective layer, a protective film, a barrier layer, and the like, all of which are extensively discussed in co-pending application Ser. Nos. 11/871,767 and 11/504,822. Examples of suitable overcoats include synthetic polymers such as polyacrylics, epoxy, polyurethanes, polysilanes, silicones, poly(silico-acrylic) and so on. Suitable anti-glare materials are well known in the art, including without limitation, siloxanes, polystyrene/PMMA blend, lacquer (e.g., butyl acetate/nitrocellulose/wax/alkyd resin), polythiophenes, polypyrroles, polyurethane, nitrocellulose, and acrylates, all of which may comprise a light diffusing material such as colloidal or fumed silica. Examples of protective films include, but are not limited to: polyester, polyethylene terephthalate (PET), acrylate (AC), polybutylene terephthalate, polymethyl methacrylate (PMMA), acrylic resin, polycarbonate (PC), polystyrene, triacetate (TAC), polyvinyl alcohol, polyvinyl chloride, polyvinylidene chloride, polyethylene, ethylene-vinyl acetate copolymers, polyvinyl butyral, metal ion-crosslinked ethylene-methacrylic acid copolymers, polyurethane, cellophane, polyolefins or the like; particularly preferable are AC, PET, PC, PMMA, or TAC.

### Durability of Conductive Films

As described herein, an overcoat provides a barrier that shields the underlying nanostructure network layer from environmental factors that can potentially cause an increase of the sheet resistance of the conductive film. In addition, an overcoat can impart structural reinforcement to the conductive film, thereby enhancing its physical durability, such as mechanical durability.

To enhance the mechanical durability of the conductive film structure (conductive layer topped with overcoat layer), it is necessary to either increase the mechanical stability of the structure or to limit the abrasion inflicted on the structure when in contact with other surfaces, or a combination of these approaches.

To increase the mechanical stability of both the conductive film and the overcoat, filler particles can be embedded in the overcoat, the conductive film, or both. If the diameter of the particle is bigger than the thickness of the overcoat layer, these particles will create a rough surface of the overcoat. This roughness provides a spacer so that another surface (for example, in a touch panel application) does not come into direct contact with the overcoat layer or conductive layer and therefore is less likely to mechanically damage the film (e.g., through abrasion). In addition, mechanically hard particles, which can also be smaller than the overcoat, offer structural support of the layer and diminish abrasion of the layer.

Thus, one embodiment describes a conductive film comprising: a nanostructure network layer including a plurality of silver nanostructures and having less than 2000 ppm silver complex ions in total; and an overcoat overlying the nanostructure network layer, the overcoat further comprising filler particles. In other embodiments, the nanostructure network layer further comprises filler particles. In further embodiments, both the overcoat and the nanostructure network layer further comprise filler particles. In any of the above embodiments, one or more corrosion inhibitors can also be present in the overcoat, the nanostructure network layer or both.

In certain embodiments, the filler particles are nano-sized structures (also referred to as “nano-fillers”), as defined herein, including nanoparticles. The nano-fillers can be electrically conductive or insulating particles. Preferably, the nano-fillers are optically transparent and have the same index of refraction as the overcoat material so as not to alter the optical properties of the combined structure (conductive layer and overcoat layer), e.g., the filler material does not affect the light transmission or haze of the structure. Suitable filler materials include, but are not limited to, oxides (such as ITO, silicon dioxide particles, aluminum oxide (Al₂O₃), ZnO, and the like), and polymers (such as polystyrene and poly(methyl methacrylate)).

The nano-fillers are typically present at a w/w % concentration (based on solid and dry film) of less than 25%, less than 10%, or less than 5%.

As an alternative or additional approach, lowering the surface energy of the overcoat layer can reduce or minimize abrasion inflicted on the conductive film.

Thus, in one embodiment, the conductive film can further comprise a surface energy-reducing layer overlying the overcoat layer. A surface energy-reducing layer can lower the abrasion inflicted on the film. Examples of surface energy-reducing layers include, but are not limited to, Teflon®.

A second method of reducing surface energy of the overcoat is to carry out a UV cure process for the overcoat in a nitrogen or other inert gas atmosphere. This UV cure process produces a lower surface tension overcoat due to the presence of a partially or fully polymerized overcoat, resulting in greater durability (see, e.g., Example 11). Thus, in one embodiment, the overcoat of the conductive film is cured under an inert gas.

In a further embodiment, additional monomers may be incorporated into the overcoat solution before the coating process. The presence of these monomers reduces surface energy following the coating and curing process. Exemplary monomers include, but are not limited to, fluorinated acrylates (such as 2,2,2-trifluoroethyl acrylate, perfluorobutyl acrylate and perfluoro-n-octyl acrylate) and acrylated silicones (such as acryloxypropyl and methacryloxypropyl-terminated polydimethylsiloxanes). Typically, the molecular weights of the monomers range from 350 to 25,000 amu.

In a further embodiment, reduction of surface energy is achieved by transferring a very thin layer (possibly a monolayer) of low surface energy material onto the overcoat. For example, a substrate already coated with the low surface energy material can be laminated onto the surface of the overcoat. The lamination can be carried out at ambient or elevated temperatures. The substrate can be a thin plastic sheet, such as a commercially available release liner (e.g., silicone or non-silicone-coated release liners by Rayven). When the release liner is removed, a thin layer of the release material remains on the surface of the overcoat, thereby lowering the surface energy significantly. An additional advantage of this method is that the conductive film structure is protected by the release liner during transport and handling.

In any of the embodiments described herein, the conductive films can be optionally treated in a high-temperature annealing process to further enhance the structural durability of the film.

The various embodiments described herein are further illustrated by the following non-limiting examples.

### EXAMPLES

### Example 1

### Standard Synthesis of Silver Nanowires

Silver nanowires were synthesized by a reduction of silver nitrate dissolved in ethylene glycol in the presence of poly(vinyl pyrrolidone) (PVP). Ethylene glycol, or other polyols such as propylene glycol, serves the dual functions of a solvent and a reducing agent. This synthetic approach is also referred to as the “polyol” method. An example was described in, e.g., Y. Sun, B. Gates, B. Mayers, & Y. Xia, “Crystalline silver nanowires by soft solution processing”, Nanolett, (2002), 2(2): 165-168. Uniform silver nanowires can be selectively isolated by centrifugation or other known methods.

Alternatively, uniform silver nanowires can be synthesized directly by the addition of a suitable ionic additive (e.g., tetrabutylammonium chloride or tetrabutylammonium bromide) to the above reaction mixture. The silver nanowires thus produced can be used directly without a separate step of size-selection. This synthesis is described in more detail in applicants' co-owned and co-pending U.S. patent application Ser. No. 11/766,552, which application is incorporated herein in it its entirety.

The synthesis could be carried out in ambient light (standard) or in the dark to minimize photo-induced degradation of the resulting silver nanowires.

In the following examples, silver nanowires of 20 nm to 80 nm in width and about 8 μm-25 μm in length were used. Typically, better optical properties (higher transmission and lower haze) can be achieved with higher aspect ratio wires (i.e., longer and thinner).

### Example 2

### Standard Preparation of Conductive Films

A typical ink composition for depositing metal nanowires comprises, by weight, from 0.0025% to 0.1% surfactant (e.g., a preferred range is from 0.0025% to 0.05% for ZONYL® FSO-100), from 0.02% to 4% viscosity modifier (e.g., a preferred range is 0.02% to 0.5% for hydroxypropyl methylcellulose (HPMC), from 94.5% to 99.0% solvent and from 0.05% to 1.4% metal nanowires. Representative examples of suitable surfactants include ZONYL® FSN, ZONYL® FSO, ZONYL® FSA, ZONYL® FSH, Triton (x100, x114, x45), TERGITOL®, DYNOL® (604, 607), n-dodecyl β-D-maltoside, and NOVEC®. Examples of suitable viscosity modifiers include hydroxypropyl methyl cellulose (HPMC), methyl cellulose, xanthan gum, polyvinyl alcohol, carboxy methyl cellulose, and hydroxy ethyl cellulose. Examples of suitable solvents include water and isopropanol.

The ink composition can be prepared based on a desired concentration of the nanowires, which is an index of the loading density of the final conductive film formed on the substrate.

The substrate can be any material onto which nanowires are deposited. The substrate can be rigid or flexible. Preferably, the substrate is also optically clear, i.e., light transmission of the material is at least 80% in the visible region (400 nm-700 nm).

Examples of rigid substrates include glass, polycarbonates, acrylics, and the like. In particular, specialty glass such as alkali-free glass (e.g., borosilicate), low alkali glass, and zero-expansion glass-ceramic can be used. The specialty glass is particularly suited for thin panel display systems, including Liquid Crystal Display (LCD).

Examples of flexible substrates include, but are not limited to: polyesters (e.g., polyethylene terephthalate (PET), polyester naphthalate, and polycarbonate), polyolefins (e.g., linear, branched, and cyclic polyolefins), polyvinyls (e.g., polyvinyl chloride, polyvinylidene chloride, polyvinyl acetals, polystyrene, polyacrylates, and the like), cellulose ester bases (e.g., cellulose triacetate, and cellulose acetate), polysulphones such as polyethersulphone, polyimides, silicones, and other conventional polymeric films.

The ink composition can be deposited on the substrate according to, for example, the methods described in co-pending U.S. patent application Ser. No. 11/504,822.

As a specific example, an aqueous dispersion of silver nanowires, i.e., an ink composition, was first prepared. The silver nanowires were about 35 nm to 45 nm in width and a mean length of 10 μm. The ink composition comprises, by weight, 0.2% silver nanowires, 0.4% HPMC, and 0.025% Triton x100. The ink was then spin-coated on glass at a speed of 500 rpm for 60 s, followed by post-baking at 50° C. for 90 seconds and 180° C. for 90 seconds. The coated film had a resistivity of about 20 ohms/sq, with a transmission of 96% (using glass as a reference) and a haze of 3.3%.

As understood by one skilled in the art, other deposition techniques can be employed, e.g., sedimentation flow metered by a narrow channel, die flow, flow on an incline, slit coating, gravure coating, microgravure coating, bead coating, dip coating, slot die coating, and the like. Printing techniques can also be used to directly print an ink composition onto a substrate with or without a pattern. For example, inkjet, flexoprinting and screen printing can be employed.

It is further understood that the viscosity and shear behavior of the fluid as well as the interactions between the nanowires may affect the distribution and interconnectivity of the nanowires deposited.

### Example 3

### Evaluation of Optical and Electrical Properties of Transparent Conductors

The conductive films prepared according to the methods described herein were evaluated to establish their optical and electrical properties.

The light transmission data were obtained according to the methodology in ASTM D1003. Haze was measured using a BYK Gardner Haze-gard Plus. The surface resistivity was measured using a Fluke 175 True RMS Multimeter or contact-less resistance meter, Delcom model 717B conductance monitor. A more typical device is a 4-point probe system for measuring resistance (e.g., by Keithley Instruments).

The interconnectivity of the nanowires and an areal coverage of the substrate can also be observed under an optical or scanning electron microscope.

### Example 4

### Removal of Chloride Ions from Silver Nanowires by Ammonia Wash

30 kg batch of silver nanowires were prepared in the dark but otherwise according to the standard procedure described in Example 1.

Following the synthesis and cooling, 1200 ppm of ammonium hydroxide was added to the 30 kg batch and then the batch was evenly divided and added (1.3 kg) to 24 separate boxes for further purification. The boxes filled with nanowires were allowed to settle for 7 days in a dark environment. The supernatant was then decanted and 500 ml 0.6% of PVP solution in water was added to the nanowires and re-suspended. The nanowires were allowed to re-settle for one day and then the supernatant was decanted. It is noted that, as a result of the rinsing, a certain amount of nitrate ions were simultaneously removed with the chloride ions.

Thereafter, 150 ml of water was added to the nanowires for re-suspension and each box was combined into one vessel to form a nanowire concentrate.

The chloride level in the silver nanowires can be measured by neutron activation. More specifically, the nanowire concentrate was subjected to the neutron activation and the chloride level in the nanowire concentrate was measured. As a comparison, a nanowire concentrate of unpurified nanowires of the same concentration was prepared and subjected to the same technique to measure the chloride level. Table 1 shows the chloride levels normalized to a 1% (w/w) nanowire concentrate of unpurified and purified nanowires, respectively. Based on the normalized levels, chloride levels as contributed by the nanowires in a dry film can be ascertained (also shown in Table 1). These results demonstrate that the purification process (e.g., ammonia wash) reduced the chloride levels in the silver nanowires by a factor of 2.

TABLE 1

Chloride Levels (ppm)

| | Unpurified Nanowires | Purified Nanowires |
|---|---|---|
| 1% Nanowire | 20.5 | 10.1 |
| Concentrate | | |
| Dry Film | 655 | 327 |

### Example 5

### Removal of Nitrate Ions from Silver Nanowires by Rinsing

30 kg batch of silver nanowires were prepared in the dark but otherwise according to the standard procedure described in Example 1. Following the synthesis and cooling the batch was added evenly to 23 separate boxes for further purification. The boxes filled with nanowires were allowed to settle for 10 days in a dark environment. The supernatant was then decanted and 500 ml of 0.6% of PVP solution in water was added to the nanowires and re-suspended. The nanowires were allowed to re-settle for one day and then the supernatant was decanted.

Thereafter, 150 ml of water was added to the nanowires for re-suspension and each box was combined into one vessel to form a nanowire concentrate.

The nitrate level in the silver nanowires can be measured via ion chromatography. More specifically, the nanowire concentrate was subjected to the ion chromatography and the nitrate level in the nanowire concentrate was measured. As a comparison, a nanowire concentrate of unpurified nanowires of the same concentration was prepared and subjected to the same technique to measure the nitrate level. Table 2 shows the nitrate levels normalized to a 1% (w/w) nanowire concentrate of unpurified and purified nanowires, respectively. Based on the normalized levels, nitrate levels as contributed by the nanowires in a dry film can be ascertained (also shown in Table 2). These results demonstrate that the purification process (e.g., wash) reduced the nitrate levels in the silver nanowires by a factor of 30.

TABLE 2

| | Nitrate Levels (ppm) | |
|---|---|---|
| | Unpurified Nanowires | Purified Nanowires |
| 1% Nanowire Concentrate | 60 | 2 |
| Dry Film | 2000 | 67 |

### Example 6

### Purification of HPMC

Crude HPMC (METHOCEL 311®, Dow Chemical Company, Midland, Mich.) was purified by repeated hot water rinse. More specifically, 250 g crude HPMC was stirred, to which boiling water was quickly added. The mixture was stirred at reflux for 5 minutes and then filtered hot on a preheated glass frit (M). The wet HPMC cake was immediately re-dispersed in 1 L of boiling water and stirred at reflux for 5 minutes. The hot filtration and re-dispersion step was repeated two more times. The HPMC cake was then dried in an oven at 70° C. for 3 days. Analytical results showed that the amounts of sodium ions (Na⁺) and chloride ions (Cl⁻) were substantially reduced in the purified HPMC (Table 3).

TABLE 3

| HPMC | Na⁺ (ppm) | Cr⁻ (ppm) |
|---|---|---|
| Crude | 2250 | 3390 |
| Purified | 60 | 42 |

### Example 7

### Silver Complex Ions in Ink Formulations and Dry Films

Silver nanowire ink formulations were prepared by dispersing silver nanowires and HPMC in a liquid carrier (e.g., water). Two types of ink formulations were prepared with and without surfactants. Table 4 shows the weight percentages of the non-volatile components in the ink formulations. The ink formulations were in turn slot die-coated on a substrate. Thereafter, dry films of silver nanostructures formed as water evaporated. Table 4 further shows the weight percentages of the non-volatile components in the dry films.

TABLE 4

| | With Surfactant | | Without Surfactant | |
|---|---|---|---|---|
| | Ink | Dry Film | Ink | Dry Film |
| | (w/w %) | (w/w %) | (w/w %) | (w/w %) |
| Silver nanowires | 0.05 | 26.74 | 0.05 | 33.33 |
| HPMC | 0.1 | 53.48 | 0.1 | 66.67 |
| FSO (surfactant) | 0.005 | 2.67 | — | — |
| FSA (surfactant) | 0.032 | 17.11 | — | — |

The silver nanowires were purified by ammonia wash or water rinse to remove the silver complex ions (including chloride and/or nitrate) according to the methods described in Examples 4 and 5, respectively. In addition, HPMC was purified according to the method described in Example 6.

The levels of silver complex ions in the ink formulations were measured and normalized to an ink formulation having 0.05% by weight of silver nanostructures in accordance with the method described in Examples 4 and 5. The results are shown in Table 5 (with surfactant) and Table 6 (without surfactant). The weight percentages of silver complex ions in the dry films were calculated according to their levels in the corresponding ink formulations.

TABLE 5
SILVER COMPLEX IONS IN INK
AND FILM WITH SURFACTANT

| | | Ammonia | |
|---|---|---|---|
| Silver Complex Ions (ppm) | | Rinse (Ex. 4) | Rinse (Ex. 5) |
| Silver | chloride | 267 | 963 |
| nanowires | nitrate | 27 | 53 |
| HPMC | chloride | 11 | 11 |
| surfactants | chloride | 14 | 14 |

| | | |
|---|---|---|
| Total silver complex ions in dry film (ppm) | 319 | 1040 |
| Total silver complex ions in ink (0.05% | 0.60 | 1.94 |
| silver nanostructures) | | |

TABLE 6
SILVER COMPLEX IONS IN INK
AND FILM WITHOUT SURFACTANT

| | | Ammonia | |
|---|---|---|---|
| Silver Complex Ions (ppm) | | Rinse (Ex. 4) | Rinse (Ex. 5) |
| Silver | chloride | 333 | 1200 |
| nanowires | nitrate | 33 | 67 |
| HPMC | chloride | 13 | 13 |

| | | |
|---|---|---|
| Total silver complex ions in dry film (ppm) | 379 | 1213 |
| Total silver complex ions in ink (0.05% | 0.57 | 1.92 |
| silver nanostructures) | | |

### Example 8

### Effect of Silver Complex Ions Removal from Silver Nanowires on Film Reliability

Two ink formulations comprising silver nanowires were prepared by a purified process and a standard process. The first ink was prepared by using nanowires that were synthesized in the dark and purified to remove silver complex ions (e.g., chloride and nitrate) according to the process described in Examples 4 and 5. The second ink was formulated by using nanowires that were synthesized in a standard manner (in ambient light) and without removing the silver complex ions (e.g., chloride and/or nitrate).

High purity HPMC, prepared according to the method described in Example 6, was used in each ink.

Each ink was made separately by adding 51.96 g of 0.6% high purity HPMC to a 500 ml NALGENE bottle. 10.45 g of purified and unpurified nanowires (1.9% Ag) were added, respectively, to the first and second ink formulations and shaken for 20 seconds. 0.2 g of a 10% ZONYL® FSO solution (FSO-100, Sigma Aldrich, Milwaukee, Wis.) was further added shaken for 20 seconds. 331.9 g of DI water and 5.21 g of 25% FSA (ZONYL® FSA) were added to the bottle and shaken for 20 seconds.

The inks were mixed on a roller table overnight and degassed for 30 minutes at −25″ Hg in a vacuum chamber to remove air bubbles. The inks were then coated onto 188 μm PET using a slot die coater at a pressure of 17-19 kPa. The films were then baked for 5 minutes at 50° C. and then 7 minutes at 120° C. Multiple films were processed for each ink formulation.

The films were then coated with an overcoat. The overcoat was formulated by adding to an amber NALGENE bottle: 14.95 g of acrylate (HC-5619, Addison Clearwave, Wood Dale, Ill.); 242.5 g of isopropanol and 242.5 g of diacetone alcohol (Ultra Pure Products, Richardson, Tex.). The amber bottle was shaken for 20 seconds. Thereafter, 0.125 g of TOLAD® 9719 (Bake Hughes Petrolite, Sugarland, Tex.) was added to the amber bottle and shaken for 20 seconds. The overcoat formulation was then deposited on the films using a slot die coater at a pressure of 8−10 kPa. The films were then baked at 50° C. for 2 minutes and then at 130° C. for 4 minutes. The films were then exposed to UV light at 9 feet per minute using a fusion UV system (H bulb) to cure, followed by annealing for 30 minutes at 150° C.

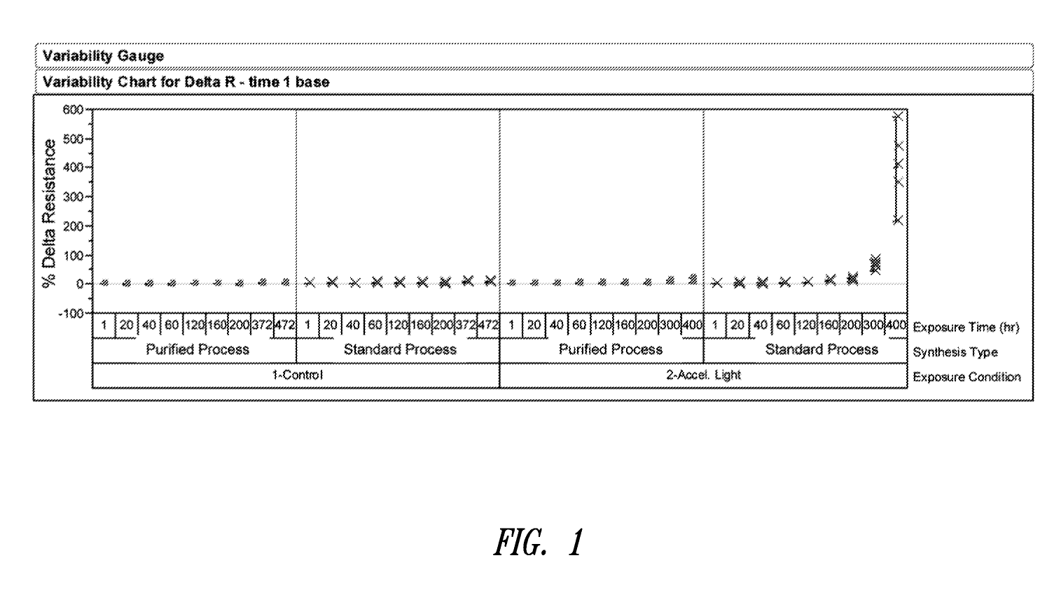

The films were split into two groups, each group being subjected to two different exposure conditions, respectively. The first exposure condition was conducted in room temperature and room light (control), while the second exposure condition was conducted in accelerated light (light intensity: 32,000 Lumens). The film's resistance was tracked as a function of time in each exposure condition and the percent change in resistance (ΔR) was plotted as a function of time in the variability plot shown in FIG. 1.

FIG. 1 shows that, under the control light condition (ambient light and room temperature), the resistance shift or ΔR (Y axis) was comparable for films prepared by the purified process and films prepared by the standard process. Neither showed significant drift following light exposure of nearly 500 hours.

In contrast, under the accelerated light condition, the films prepared by the standard process experienced a dramatic increase in resistance following about 300 hours of light exposure, while the films prepared by the purified process remained stable in their resistance.

This example shows that the reliability of conductive films formed of the silver nanowires could be significantly enhanced by removing chloride ions from the silver nanowires.

### Example 9

### Effect of Chloride Removal from HPMC on Film Reliability

Two ink formulations were prepared using purified silver nanowires. The first ink formulation was prepared with purified HPMC (see Example 6). The second ink formulation was prepared with commercial HPMC (standard).

Conductive films were otherwise prepared following the same process described in Example 8.

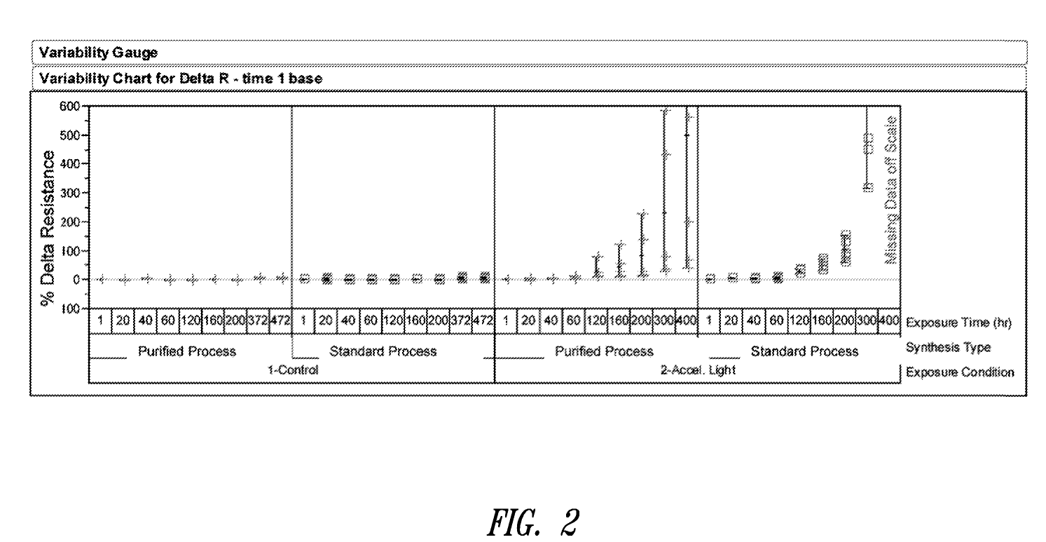

FIG. 2 shows that, under the control light condition, conductive films prepared by the purified process and the standard process showed comparable resistance shift (ΔR) following nearly 500 hours of light exposure. In contrast, under the accelerated light condition, both conductive films experienced increases in resistance shift (ΔR). However, the resistance shift (ΔR) was much more dramatic for conductive films made with crude HPMC as compared to those made with purified HPMC.

This example shows that the reliability of conductive films formed of the silver nanowires could be significantly enhanced by removing chloride ions from the ink components, such as HPMC.

### Example 10

### Effect of Corrosion Inhibitor in Ink on Film Reliability

Two ink formulations were prepared using purified silver nanowires and purified HPMC (see, Examples 4, 5 and 6), one of which was further incorporated with a corrosion inhibitor.

The first ink was prepared by adding 51.96 g of 0.6% high purity HPMC (METHOCEL® 311, Dow Chemical Company, Midland, Mich.) to a 500 ml NALGENE bottle. Thereafter, 10.45 g of purified silver nanowires (1.9% Ag), 0.2 g of a 10% ZONYL® FSO solution (FSO-100, Sigma Aldrich, Milwaukee, Wis.), 331.9 g of DI water and a corrosion inhibitor: 5.21 g of 25% FSA (ZONYL® FSA, DuPont Chemicals, Wilmington, Del.) were sequentially added and the bottle was shaken for 20 seconds following the addition of each component.

The second ink was prepared in the same manner except without the ZONYL® FSA.

The inks were mixed on a roller table overnight and degassed for 30 minutes at −25″ Hg in a vacuum chamber to remove air bubbles. The films were then baked for 5 minutes at 50° C. and then 7 minutes at 120° C. Multiple films were processed for each ink formulation.

The films were then coated with an overcoat. The overcoat was formulated by adding to an amber NALGENE bottle: 14.95 g of acrylate (HC-5619, Addison Clearwave, Wood Dale, Ill.); 242.5 g of isopropanol and 242.5 g of diacetone alcohol (Ultra Pure Products, Richardson, Tex.). The amber bottle was shaken for 20 seconds. Thereafter, 0.125 g of TOLAD® 9719 (Bake Hughes Petrolite, Sugarland, Tex.) was added to the amber bottle and shaken for 20 seconds. The overcoat formulation was then deposited on the films using a slot die coater at a pressure of 8−10 kPa. The films were then baked at 50° C. for 2 minutes and then at 130° C. for 4 minutes. The films were then exposed to UV light at 9 feet per minute using a fusion UV system (H bulb) to cure, followed by annealing for 30 minutes at 150° C.

Three films produced with each ink type were placed in three environmental exposure conditions: room temperature control, 85° C. dry and 85° C./85% Relative Humidity. The percent change in resistance (ΔR) was tracked as a function of time in each exposure condition.

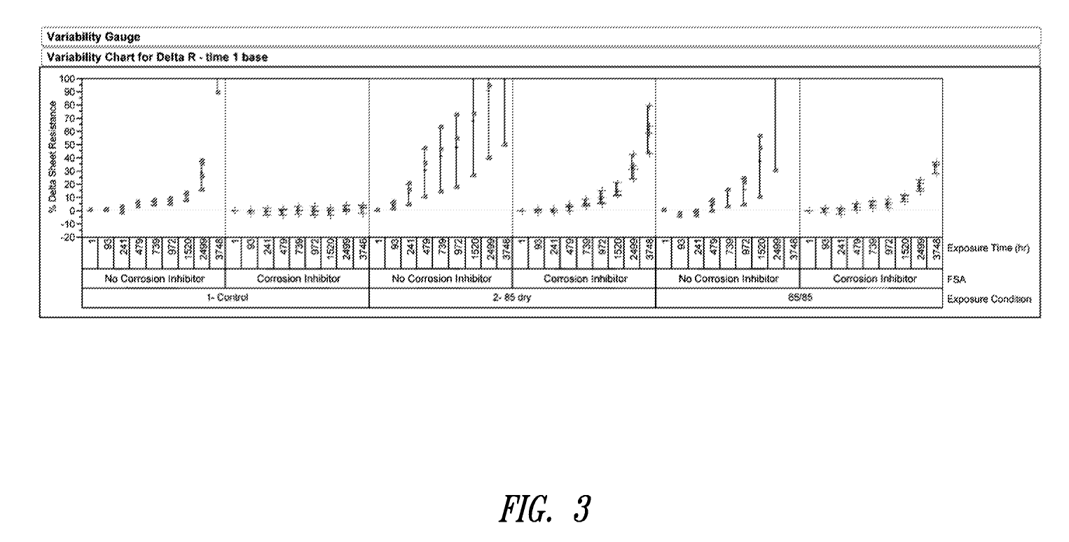

FIG. 3 shows that, under all three environmental exposure conditions, films without the corrosion inhibitor experienced markedly more resistance shift than films incorporated with the corrosion inhibitor.

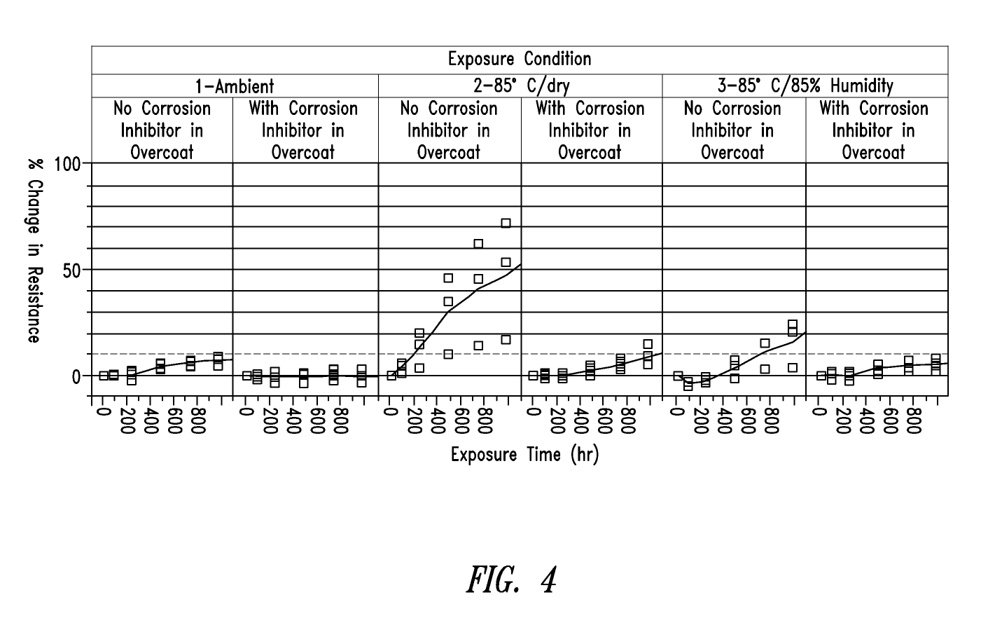

FIG. 4 and Table 7 show the effects of the corrosion inhibitors in the ink formulations in additional conductive film samples. As shown, when a corrosion inhibitor was incorporated in an ink formulation, resistance stability was dramatically improved at an elevated temperature of 85° C. and dry condition (<2% humidity), as compared to a similarly prepared sample but without the corrosion inhibitor in the corresponding ink formulation. For instance, in samples without the corrosion inhibitor, the resistance increased by more than 10% in under 200 hr at 85° C. In samples with the corrosion inhibitor, the resistance shift remained less than 10% for about 1000 hr.

At an elevated temperature with elevated humidity (85° C./85% humidity), without corrosion inhibitor in the ink formulation, the resistance increased by more than 10% on average in just over 700 hr. With corrosion inhibitor, resistance change remained less than 10% well beyond 1000 hr.

TABLE 7
CORROSION INHIBITOR IN OVERCOAT

| | | % Change in Resistance | | | | | | |
|---|---|---|---|---|---|---|---|---|
| | Exposure | No Corrosion Inhibitor | | | With Corrosion Inhibitor | | | |
| Time (hr) | Condition | Sample 1 | Sample 2 | Sample 3 | Sample 1 | Sample 2 | Sample 3 | Sample 4 |
| 1 | ambient | 0.0 | 0.0 | 0.0 | 0.0 | 0.0 | 0.0 | 0.0 |
| 112 | | 1.0 | 0.8 | 1.5 | 0.5 | 0.5 | 0.5 | 0.5 |
| 248 | | 3.1 | 2.1 | 2.6 | 1.1 | 1.0 | 0.5 | 1.0 |
| 503 | | 6.8 | 3.3 | 5.1 | 1.1 | 1.0 | 0.9 | 2.1 |
| 615 | | 9.9 | 4.5 | 7.1 | 1.6 | 0.5 | 0.5 | 1.5 |
| 775 | | 14.1 | 7.0 | 10.7 | 1.6 | 1.0 | 0.5 | 2.6 |
| 886 | | 25.0 | 9.5 | 13.8 | 1.1 | 1.5 | 1.8 | 3.1 |
| 1026 | | 53.1 | 11.1 | 17.9 | 2.6 | 1.5 | 1.4 | 2.1 |
| 1 | 85° C. | 0.0 | 0.0 | 0.0 | 0.0 | 0.0 | 0.0 | |
| 112 | <2% | 6.9 | 8.3 | 7.3 | 0.5 | 0.0 | 1.0 | |
| 248 | humidity | 11.0 | 12.0 | 10.7 | 1.0 | 0.5 | 1.0 | |
| 503 | | 17.0 | 19.3 | 18.0 | 1.0 | 1.4 | 2.1 | |
| 615 | | 20.2 | 21.9 | 20.5 | 1.6 | 1.4 | 2.1 | |
| 775 | | 23.9 | 26.0 | 24.9 | 1.6 | 1.4 | 2.1 | |
| 886 | | 26.6 | 29.7 | 29.3 | 2.1 | 1.9 | 2.1 | |
| 1026 | | 29.4 | 31.8 | 31.2 | 1.6 | 1.4 | 2.1 | |
| 1 | 85° C. | 0.0 | 0.0 | 0.0 | 0.0 | 0.0 | 0.0 | |
| 112 | 85% | 1.4 | 3.3 | 3.1 | 3.3 | 2.5 | 2.6 | |
| 248 | humidity | 11.1 | 19.9 | 16.5 | 8.0 | 5.1 | 5.2 | |
| 503 | | 32.2 | 46.9 | 40.2 | 23.0 | 14.7 | 13.1 | |
| 615 | | 41.3 | 57.8 | 51.0 | 29.1 | 19.8 | 17.8 | |
| 775 | | 58.7 | 78.7 | 67.5 | 40.4 | 26.9 | 25.7 | |
| 886 | | 71.2 | 93.4 | 78.9 | 46.5 | 32.0 | 31.4 | |
| 1026 | | 87.0 | 112.3 | 97.4 | 54.0 | 38.1 | 36.6 | |

### Example 11

### Effect of Corrosion Inhibitor in Overcoat on Film Reliability

An ink formulation was prepared, which contained purified silver nanowires, purified HPMC and a first corrosion inhibitor ZONYL® FSA (see Examples 4, 5. 6 and 10). More specifically, the ink was prepared by adding 51.96 g of 0.6% high purity HPMC (METHOCEL® 311, Dow Chemical Company, Midland, Mich.) to a 500 ml NALGENE bottle. Thereafter, 10.45 g of purified silver nanowires (1.9% Ag), 0.2 g of a 10% ZONYL® FSO solution (FSO-100, Sigma Aldrich, Milwaukee, Wis.), 331.9 g of DI water and 5.21 g of 25% FSA (ZONYL® FSA, DuPont Chemicals, Wilmington, Del.) were sequentially added and the bottle was shaken for 20 seconds following the addition of each component.

The inks were mixed on a roller table overnight and degassed for 30 minutes at −25″ Hg in a vacuum chamber to remove air bubbles. The films were then baked for 5 minutes at 50° C. and then 7 minutes at 120° C. Multiple films were processed for each ink formulation.

The films were then split into two groups. One group was coated with an overcoat containing a second corrosion inhibitor: TOLAD® 9719 (see Example 10). The other group was coated with an overcoat containing no corrosion inhibitor. All of the films were dried and cured at 0.5 J/cm2 at UVA light with a high N₂ flow with the O₂ content in the UV zone at or less than about 500 ppm.

Three films per group were placed in three environmental exposure conditions: room temperature control, 85° C. dry and 85° C./85% Relative Humidity. The percent change in resistance (ΔR) was tracked as a function of time in each exposure condition.

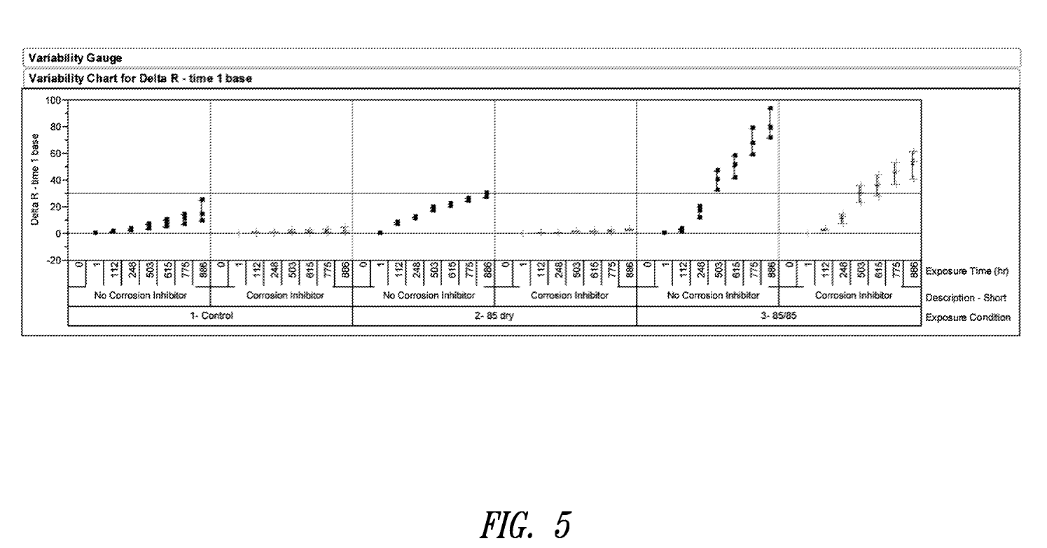

FIG. 5 shows that, under all three environmental exposure conditions, films without the corrosion inhibitor in the overcoat experienced markedly more resistance shift than films with the corrosion inhibitor in the overcoat. Overcoats with the corrosion inhibitor were particularly effective for maintaining the film reliability under the control and 85° C. dry conditions.

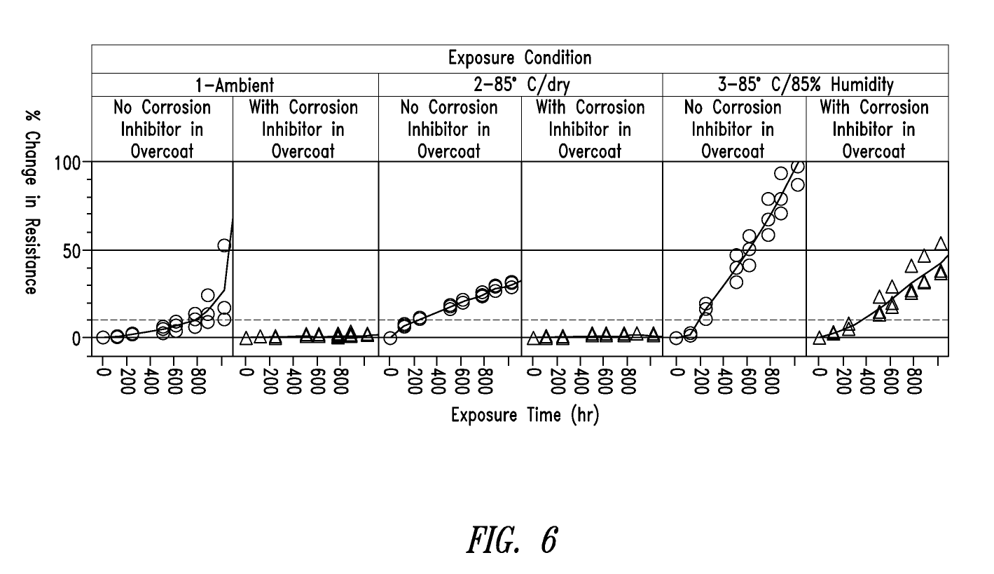

FIG. 6 and Table 8 show the effects of the corrosion inhibitors in the overcoats in additional conductive film samples. As shown, when a corrosion inhibitor was incorporated in an overcoat, resistance stability was dramatically improved at an elevated temperature of 85° C. and dry condition (<2% humidity), as compared to a similarly prepared sample but without the corrosion inhibitor in the overcoat. For instance, for films without corrosion inhibitor in the overcoat, the resistance increased by more than 10% in under 200 hr at 85° C. For films with the corrosion inhibitor in the overcoat, resistance change remained less than 10% well past 1000 hr. Including corrosion inhibitor in the overcoat somewhat improved resistance stability in elevated temperature and elevated humidity (85° C./85%). For films without the corrosion inhibitor in the overcoat, resistance increased by more than 10% in under 200 hr. For films with the corrosion inhibitor in the overcoat, resistance change did not exceed 10% until after 300 hr.

TABLE 8
CORROSION INHIBITOR IN INK

| | | % Change in Resistance | | | | | | | |
|---|---|---|---|---|---|---|---|---|---|
| Time | Exposure | No Corrosion Inhibitor | | | | With Corrosion Inhibitor | | | |
| (hr) | Condition | Sample 1 | Sample 2 | Sample 3 | Sample 4 | Sample 1 | Sample 2 | Sample 3 | Sample 4 |
| 1 | ambient | 0.0 | 0.0 | 0.0 | 0.0 | 0.0 | 0.0 | 0.0 | 0.0 |
| 93 | | 0.0 | 0.0 | 0.6 | 0.7 | −1.7 | 0.9 | −0.6 | −0.7 |
| 241 | | −2.2 | 2.5 | 0.6 | 1.7 | −3.3 | 1.7 | −0.6 | −0.7 |
| 479 | | 2.8 | 5.9 | 5.5 | 3.6 | −3.3 | 1.3 | 0.6 | 0.7 |
| 739 | | 7.3 | 6.8 | 7.4 | 4.2 | −2.5 | 3.0 | 0.0 | 0.7 |
| 972 | | 9.0 | 7.6 | 8.0 | 4.7 | −3.3 | 3.0 | 0.0 | −0.7 |
| 1 | 85° C. | 0.0 | 0.0 | 0.0 | | 0.0 | 0.0 | 0.0 | 0.0 |
| 93 | <2% | 1.2 | 5.0 | 6.1 | | 0.0 | 0.7 | −1.3 | 1.1 |
| 241 | humidity | 3.7 | 15.3 | 20.1 | | −1.4 | 1.4 | 1.3 | 0.0 |
| 479 | | 9.9 | 35.0 | 46.3 | | 0.0 | 3.6 | 2.6 | 4.9 |
| 739 | | 14.3 | 46.0 | 62.8 | | 3.2 | 4.3 | 5.2 | 8.7 |
| 972 | | 17.4 | 53.7 | 72.0 | | 5.4 | 5.7 | 15.0 | 9.8 |
| 1 | 85° C. | 0.0 | 0.0 | 0.0 | | 0.0 | 0.0 | 0.0 | 0.0 |
| 93 | 85% | −2.9 | −4.7 | −3.0 | | −1.5 | 1.1 | 1.2 | 2.1 |
| 241 | humidity | −0.7 | −3.7 | −2.4 | | −2.5 | 0.0 | 1.2 | 2.1 |
| 479 | | 5.1 | −0.9 | 7.1 | | 0.5 | 5.4 | 2.5 | 5.6 |
| 739 | | 15.4 | 2.8 | 15.5 | | 2.0 | 7.0 | 3.7 | 7.0 |
| 972 | | 24.3 | 3.7 | 20.8 | | 2.0 | 5.9 | 4.9 | 8.5 |

### Example 12

### Effect of Embedded Nanoparticles in Overcoat on Film Durability

An ink formulation was prepared, which comprises: 0.046% of silver nanowires (purified to remove chloride ions), 0.08% of purified HPMC (METHOCEL®, Dow Chemical Company, Midland, Mich.), 50 ppm of ZONYL® FSO surfactant (FSO-100, Sigma Aldrich, Milwaukee, Wis.) and 320 ppm of ZONYL® FSA (DuPont Chemicals, Wilmington, Del.) in deionized water. A nanowire network layer was then prepared by slot-die deposition as described in Examples 8-10.

An overcoat formulation was prepared, which comprised: 0.625% acrylate (HC-5619, Addison Clearwave, Wood Dale, Ill.), 0.006% corrosion inhibitor TOLAD® 9719 (Bake Hughes Petrolite, Sugarland, Tex.) and a 50:50 solvent mixture of isopropyl alcohol and diacetone alcohol (Ultra Pure Products, Richardson, Tex.), and 0.12% (on solids basis) ITO nanoparticles (VP Ad Nano ITO TC8 DE, 40% ITO in isopropanol, by Evonik Degussa GmbH, Essen, Germany).

The overcoat was deposited on the nanowire network layer to form a conductive film. The overcoat was first dried at 50° C., 100° C. and 150° C. sequentially, then cured under UV light and nitrogen flow.

Several conductive films were prepared according to the method described herein. Some of the conductive films were further subjected to a high-temperature annealing process.

The durability of the conductive films was tested in a set-up that simulated using the conductive film in a touch panel device. More specifically, the conductive film structure was positioned to be in touch with an ITO surface on a glass substrate having a surface tension of 37 mN/m. Spacer dots of 6 μm in height were first printed onto the ITO surface to keep the ITO surface and the conductive film apart when no pressure was applied. The durability test of the conductive film involved repeatedly sliding a DELRIN® stylus with a 0.8 mm-radius-tip and with a pen weight of 500 g over the backside of the conductive film structure, while the overcoat side of the conductive film came in touch with the ITO surface under pressure. The conductive films showed satisfactory durability (no cracks or abrasion) at 100,000, 200,000 and 300,000 strokes. This level of durability was observed in conductive films with or without the annealing process.

### Example 13

### Effect of Lowering Surface Energy on Film Durability by Lamination of a Release Liner

Conductive films were prepared according to Example 12. The surface energy on the cured overcoat side of the conductive film was measured at about 38 mN/m.

A release liner film (Rayven 6002-4) was laminated onto the cured overcoats of the conductive films at room temperature using a hand-held rubber-coated lamination roll. The laminated structures were then stored for several hours before the conductive films were used to make touch-panels for durability testing (see, Example 12). The lamination of the release liner significantly reduced the surface energy of the overcoat from about 38 to about 26 mN/m.

In contrast to the durability test described in Example 13, a freshly cleaned ITO surface on a glass substrate having a surface energy of about 62 mN/m was used. This high surface energy was caused by a very reactive surface, which led to early failure at about 100,000 strokes. In this case, the overcoat was damaged by abrasion during contacts with the reactive ITO surface and was subsequently removed while the nanowires were exposed and quickly failed to conduct.

However, when the overcoat surface was laminated with a release liner, which lowered the surface energy of the overcoat, the damaging effects of contacting the highly reactive ITO surface were mitigated and the durability test did not show any damage to the conductive film after 300,000 strokes.

### Example 14

### Effect of Nitrogen Cure on Durability

An ink formulation was prepared, which comprises: 0.046% of silver nanowires (purified to remove chloride ions), 0.08% of purified HPMC (METHOCEL®, Dow Chemical Company, Midland, Mich.), 50 ppm of ZONYL® FSO surfactant (FSO-100, Sigma Aldrich, Milwaukee, Wis.) and 320 ppm of ZONYL® FSA (DuPont Chemicals, Wilmington, Del.) in deionized water.

A nanowire network layer was then formed by depositing ink onto a 188 um AG/Clr (Anti-Glare/Clear Hard Coat) Polyether terathalate (PET) substrate with the nanowires deposited on the clear hard coat side. The deposition was performed on a roll coater via slot-die deposition and then dried in an oven to produce a conductive film.

An overcoat formulation was prepared, which comprised: 3.0% acrylate (HC-5619, Addison Clearwave, Wood Dale, Ill.), 0.025% corrosion inhibitor TOLAD® 9719 (Bake Hughes Petrolite, Sugarland, Tex.) and a 50:50 solvent mixture of isopropyl alcohol and diacetone alcohol (Ultra Pure Products, Richardson, Tex.).

The overcoat was deposited on the nanowire network layer to protect the conductive film. Two experiments were carried out. In Experiment 1, the overcoat was dried and cured under UV light at a UV dose of 1.0 J/cm² (in UVA) with no nitrogen flow. In Experiment 2, the overcoat was dried and cured at 0.5 J/cm² (in UVA) with a high nitrogen flow where the oxygen content in the UV zone was at 500 ppm. Both film types from Experiments 1 and 2 were annealed at 150° C. for 30 minutes and touch panels were prepared and tested for durability using the method described earlier. The film from Experiment 1, which had no nitrogen flow during the cure step, failed the durability test (see, Example 13) at less than 100,000 strokes, whereas the film from Experiment 2, which was cured under nitrogen flow, passed the durability test beyond 100,000 strokes.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An ink formulation comprising:
a plurality of silver nanostructures;
a liquid carrier; and
a trace amount of silver complex ions, wherein the silver complex ions and the plurality of silver nanostructures are present in a (w/w) ratio of no more than 1:65.

2. The ink formulation of claim 1 wherein the silver complex ions and the plurality of silver nanostructures are present in a (w/w) ratio of no more than 1:170.

3. The ink formulation of claim 1 wherein the silver complex ions are nitrate, fluoride, chloride, bromide, iodide ions, or a combination thereof.

4. The ink composition of claim 1 wherein the silver complex ions are bound to silver ions in the form of insoluble silver salts.

5. The ink composition of claim 4 wherein the silver complex ions are chloride, bromide, iodide ions, or a combination thereof.

6. The ink formulation of claim 5 wherein the silver nanostructures include silver nanowires that are purified to remove chloride, bromide, iodide ions, or a combination thereof.

7. The ink formulation of claim 1 further comprising a viscosity modifier.

8. The ink formulation of claim 7 wherein the viscosity modifier is HPMC that is purified to remove nitrate, fluoride, chloride, bromide, iodide ions, or a combination thereof.

9. The ink formulation of claim 1 further comprising a corrosion inhibitor.

10. A conductive film comprising:
a silver nanostructure network layer that includes a plurality of silver nanostructures and a viscosity modifier; and
no more than 2000 ppm of silver complex ions in total in the silver nanostructure network layer.

11. The conductive film of claim 10 wherein the conductive film comprises no more than 400 ppm silver complex ions in the silver nanostructure network layer.

12. The conductive film of claim 11 wherein the conductive film comprises no more than 370 ppm chloride ions in the silver nanostructure network layer.

13. The conductive film of claim 10 wherein the silver complex ions are bound to silver ions in the form of insoluble silver salts.

14. The conductive film of claim 10 wherein the silver complex ions are chloride, bromide, iodide ions, or a combination thereof.

15. The conductive film of claim 10 wherein the conductive film further comprises a first corrosion inhibitor.

16. The conductive film of claim 10 wherein the conductive film further comprises an overcoat overlying the metal nanostructure network layer.

17. The conductive film of claim 16 wherein the overcoat comprises a second corrosion inhibitor.

18. The conductive film of claim 10 wherein the silver nanostructure network layer further comprises one or more surfactants.

19. The conductive film of claim 10 wherein the viscosity modifier is HPMC.

20. The conductive film of claim 10 having a sheet resistance that shifts no more than 20% during exposure to a temperature of at least 85° C. for at least 250 hours.
